(19) United States
(12) Patent Application Publication
(10) Pub. No.: US 2002/0045679 A1
(43) Pub. Date: Apr. 18, 2002

(54) Aqueous ink composition

(76) Inventors: Nagayuki Takao, Ryugasaki-shi (JP); Takahiro Furutani, Suita-shi (JP)

Correspondence Address: BIRCH STEWART KOLASCH & BIRCH, PO BOX 747, FALLS CHURCH, VA, 22040-0747, US

(21) Appl. No.: 09/924,679

(22) Filed: Aug. 9, 2001

(30) Foreign Application Priority Data
Aug. 11, 2000 (JP) 2000-244428

(51) Int. Cl. C09D 5/00

(52) U.S. Cl. 523/161

(57) ABSTRACT

The object of the present invention is to provide an aqueous ink composition which shows excellent drying characteristics for impermeable printing materials such as plastic films without using apparatuses such as ultraviolet irradiation apparatuses and heating apparatuses and which is mild for earth environment. The aqueous ink composition of the present invention contains water, a water-soluble solvent, a water-soluble resin and a dye, and, additionally, a quick-drying property imparting agent having a solubility in the water lower than that in the water-soluble solvent.

### BACKGROUND OF THE INVENTION

The present invention relates to an aqueous ink composition which is excellent in quick-drying property and mild for earth environment. More particularly, it relates to an aqueous fluorescent ink composition which is excellent in quick-drying property and mild for earth environment.

Recently, developments have been extensively made utilizing properties of fluorescent materials, such as various cards used for security, factory automation (FA), for material handling, and the like. One example is utilization for mailing, namely, bar codes are printed with an ink containing a fluorescent material, and postal matters are sorted by code control and distributed.

As the fluorescent materials, there have been used fluorescent complexes comprising a rare earth element as a luminescence center with which a low molecular ligand is coordinated, and inks containing them are prepared. These are disclosed, for example, in JP-A-8-239607, JP-A-9-188835, JP-A-11-279474 and JP-A-11-510213. These fluorescent complexes are homogeneously dissolved as dyes or pigments in liquids such as solvents to prepare inks.

However, since organic solvents are used in these inks, they have the problems, e.g., environmental pollution such as air pollution, labor safety and hygiene such as poisoning by organic solvent, and danger of igniting to cause explosion. As one means to solve the above problems, it has been proposed to use aqueous inks which utilize water or aqueous solvents high in safety as solvents (e.g., JP-B-54-22336).

However, the aqueous inks suffer from the problem that they are inferior to conventional organic solvent type inks in drying property because water is contained in the ink compositions. In order to solve this problem, it has been proposed to improve the apparent drying property by adding a penetrant to the ink to increase the permeation speed of the ink through the material on which printing is carried out (hereinafter referred to as “printing material”). (See, for example, JP-8-239609 and JP-A-8-253715). The effect can be exerted when the printing materials are high in permeability to ink, such as paper, but impermeable materials such as plastic films are low in the effect.

Under the circumstances, there is a proposal according to which the drying property of the impermeable printing materials is improved by utilizing ultraviolet curing or heat curing (e.g., JP-A-10-7956). In this case, however, extra apparatuses such as an ultraviolet irradiation apparatus and a heating apparatus are needed for improving the drying property of inks, which cause loss of convenience and, besides, increase of printing cost.

### SUMMARY OF THE INVENTION

Thus, the object of the present invention is to provide an aqueous ink composition which shows excellent drying property for impermeable printing materials such as plastic films without using apparatuses such as ultraviolet irradiation apparatuses and heating apparatuses and which is mild for earth environment.

The above object has been attained by an aqueous ink composition containing water, a water-soluble solvent, a water-soluble resin and a dye, to which is further added a quick-drying property imparting agent having a solubility in water lower than the solubility in the above water-soluble solvent.

As mentioned above, the ink drying property of the aqueous ink composition of the present invention is improved by utilizing the difference in solubility of the quick-drying property imparting agent in water and in the water-soluble solvent. The solubility in water of the quick-drying property imparting agent used in the aqueous ink composition of the present invention must be lower than the solubility in the water-soluble solvent. The solubility in water of the quick-drying property imparting agent is preferably 10 wt % or lower, and its melting point is preferably 20-250° C.

It is considered that the quick-drying property imparting agent weakens the interaction between water and the water-soluble solvent and makes easier the dyes and others to exist on the side of the water-soluble solvent. Furthermore, since the quick-drying property imparting agent is lower in solubility in water than in the water-soluble solvent, it precipitates or separates when a part of the water-soluble solvent other than water is evaporated. It is considered that as a result, dyes and others are instantaneously fixed on the printing material to result in remarkable improvement of the drying property. Hereinafter, an additive which can enhance the ink dryability (fixability) utilizing the difference between the solubility in water and the solubility in the water-soluble solvent is defined as a quick-drying property imparting agent in the present invention.

In the preferred embodiments of the present invention, ink dryability (fixability) of the aqueous ink composition containing water, a water-soluble solvent, a water-soluble resin, a dye and a quick-drying property imparting agent can be remarkably improved when the ratio of the water and the water-soluble solvent is 9:1-3:7, the solubility of the quick-drying property imparting agent in water is lower than that in the water-soluble solvent, and the solubility (25° C.) of the dye in water is lower than 20 wt %.

### DETAILED DESCRIPTION OF THE INVENTION

As water added to the aqueous ink composition of the present invention, there may be used optional water such as tap water, well water, distilled water, deionized water, pure water or the like. Pure water and deionized water are preferred in order to avoid clogging of the tip of head caused by impurities contained in water.

Content of water in the aqueous ink composition of the present invention is preferably in the range of 30-95 wt %. If the content of water in the aqueous ink composition is lower than 30 wt %, flash point of the composition is low to increase the danger, and this is not preferred. If the content is higher than 95 wt %, sometimes, drying of ink is slow and, besides, the dye cannot be dissolved, and this is not preferred. Taking into consideration the balance between the drying and the safety (particularly, flammability) of the aqueous ink composition, the water content in the aqueous ink composition of the present invention is more preferably in the range of 35-85 wt %.

As the water-soluble solvents added to the aqueous ink composition of the present invention, mention may be made of, for example, alcohols such as methyl alcohol, ethyl alcohol, n-butyl alcohol, isobutyl alcohol, tert-butyl alcohol, n-propyl alcohol and isopropyl alcohol; amides such as dimethylformaldehyde and dimethylacetamide; ketones such as methyl ethyl ketone; ethers such as tetrahydrofuran, dioxane, ethylene glycol methyl ether, ethylene glycol ethyl ether, diethylene glycol methyl ether, diethylene glycol ethyl ether, triethylene glycol monomethyl ether and triethylene glycol monoethyl ether; polyhydric alcohols such as ethylene glycol, propylene glycol, butylene glycol, triethylene glycol, 1,2,6-hexanetriol, thiodiglycol, diethylene glycol, polyethylene glycol, polypropylene glycol and glycerin; N-methyl-pyrrolidone, 1,3-dimethyl-2-imidazolidinone, and the like.

For obtaining excellent drying property, it is preferred that boiling point of the water-soluble solvent is lower than that of water or vapor pressure of the water-soluble solvent is higher than that of water. Practically, alcohols of 3 or less carbon atoms are more preferred, and ethanol and propanol are most preferred.

The ratio of water and the water-soluble solvent in the aqueous ink composition of the present invention is preferably 9:1-3:7. For obtaining proper drying property, the ratio of water and the water-soluble solvent is more preferably 7:3-4:6. If the proportion of water is too high, it becomes difficult to preferentially vaporize the water-soluble solvent, and this is not preferred. On the other hand, if the proportion of water is too low, the flash point lowers to cause increase of danger, and this is not preferred.

It is more preferred that the water-soluble resin added to the aqueous ink composition of the present invention is at least one resin selected from polyvinylpyrrolidone, polyvinyl alcohol, polyurethane, polyacrylic acid, polyether and copolymers thereof. Since these resins are high in water-solubility and, besides, can stably coordinate with dyes, a high emission intensity of ink can be realized.

Amount of the water-soluble resin added to the aqueous ink composition of the present invention is preferably in the range of 0.1-8 wt %. If the amount of the water-soluble resin is less than 0.1 wt %, the ink emission intensity cannot be enhanced. On the other hand, if the amount of the water-soluble resin is more than 8 wt %, viscosity of the ink composition increases and printing failure is sometimes caused. The amount of the water-soluble resin is more preferably in the range of 2-8 wt %.

The dyes added to the aqueous ink composition of the present invention include, for example, fluorescent dyes, inorganic dyes, organic dyes and solvent-insoluble dyes. These dyes may be used each alone or in admixture of two or more. The solubility of the dyes in water is preferably lower than that of the water soluble solvent, and particularly, the solubility at 25° C. is preferably not higher than 10 wt %. If the solubility of the dyes in water is higher than 10 wt %, sometimes, sufficient drying property cannot be obtained, and this is not preferred. The solubility of the dyes in water is more preferably in the range of 0-5 wt %.

It is preferred to use fluorescent dyes as the dyes in the aqueous ink composition of the present invention. As the fluorescent dyes, preferred are those which comprise a rare earth element and a ligand. The rare earth element which is a luminescence center of the fluorescent dyes preferably comprises at least one element selected from europium, dysprosium, terbium, neodymium, praseodymium, samarium, gadolinium, holmium, erbium, and thulium. These elements can form stable fluorescent complexes and a sufficient emission intensity can be obtained.

Among the above rare earth elements, europium is most preferred in the case of application of the aqueous ink composition to security, FA, various cards, bar code systems or the like. When europium is the luminescence center, the emission has red color and 615±20 nm. Therefore, printed marks emit visible light on the above longer wavelength side by excitation with ultraviolet rays, and, hence, the color of background gives little influence and detection can be performed with high sensitivity by a silicon photo diode or the like. The emission of blue or green is sometimes difficult to detect. When a mark which emits blue light is formed on a white paper impregnated with a fluorescent brightener, since the background also emits light, the difference in light volume of emission substantially decreases, and the detection is sometimes impossible. Furthermore, if a silicon photo diode which is generally inexpensive and easily available-is used as an optoelectric transducer in detection of emitted visible light, photorecepting sensitivity for the visible light becomes lower on the shorter wavelength side than the longer wavelength side, and the sensitivity for blue or green visible light of relatively short wavelength is less than half the sensitivity for the visible light of longer wavelength side of about 600 nm, and, thus, sufficient detection sensitivity cannot sometimes be obtained.

The ligands include, for example, thenoyltrifluoroacetone, naphthoyltrifluoroacetone, benzoyltrifluoroacetone, methylbenzoyltrifluoroacetone, furoyltrifluoroacetone, pivaloyltrifluoroacetone, hexafluoroacetylacetone, trifluoroacetylacetone, fluoroacetylacetone, heptafluorobutanoylpivaloylmethane, 8-hydroquinoline, 8-mercaptoquinoline, tri-n-butyl phosphate, tri-n-butylphosphine oxide, tri-n-octylphosphine oxide, di-n-butyl sulfoxide, pyridine, a -picoline, -picoline, y-picoline, piperidine, quinoline, and the like. There is no special limitation as far as the compounds contain in the molecule the coordination sites of nitrogen, oxygen, sulfur, phosphorus elements, and the like. Moreover dendrite compounds or inclusion compounds such as dendrimer or calix arene can take rare earth elements into the molecule, and, hence, they can form more stable complexes. Furthermore, high molecular ligands containing the above elements may also be used. Among them, thenoyltrifluoroacetone and naphthoyltrifluoroacetone are especially preferred.

Content of the fluorescent dye in the ink composition is preferably 0.1-10 wt %, more preferably 0.5-5 wt %. When the content is 0.1 wt % or more, emission intensity may not be reduced, and when it is 10 wt % or less, concentration quenching can be prevented and emission intensity can be prevented from additional reduction.

The fluorescent dyes can be produced by suitable methods known to one skilled in the art. For example, it can be easily obtained by reacting a ligand such as acetylacetone with a rare earth metal halide such as europium nitrate under proper conditions.

The dyes usable in the aqueous ink composition of the present invention are preferably azo, anthraquinone, indigo, phthalocyanine, carbonyl, quinoneimine, methine, quinoline and nitro dyes.

The quick-drying property imparting agents added to the aqueous ink composition of the present invention are preferably cyclic compounds having in the molecule at least one element of nitrogen, oxygen and sulfur elements and a water-soluble functional group. As the quick-drying property imparting agents, mention may be made of, for example, bemegride, benzalphthalide, 1,2,4-benzenetricarboxylic anhydride, benzil, benzimidazole, 2-benzimidazolepropionic acid, 2-benzimidazolylacetonitrile, benzo[c]cinnoline, benzo-12-crown-4, benzo-15-crown-5, benzo-18-crown-6, 1,4-benzodioxane-6-carboxyaldehyde, 3H-1,2-benzodithiol-3-one, 2-benzofurancarboxylic acid, benzofuroxane, 2,1,3-benzothiadiazole, 2H-1,4-benzothiazin-3(4H)-one, 1,2,3-benzotriazin-4(3H)-one, 1,2,3-benzotriazole, benzotriazole-5-carboxylic acid, 1H-benzotriazole-1-methanol, 1-benzotriazolyl-9-fluorenylmethyl carbonate, N-(1H-benzotriazol-1-ylmethyl)formamide, 2H-1,4-benzoxazin-3(4H)-one, benzoxazole, 2-mercaptobenzoxazole, 2-benzoxazolinone, 2-benzoylthiophene, 2-benzylamino-4-methylpyridine, 4-benzylamino-7-nitro-2,1,3-benzoxadiazole, 6-benzylaminopurine, 2-benzylaminopyridine, (−)-2,3-0-benzylidene-L-threitol, 1-benzylimidazole, N-benzylmaleimide, (S)-(−)-4-benzyl-1-2-oxazolidinone, N-(benzyloxycarbonyloxy)succinimide, 4-benzyloxy-2-(1H)-pyridone, 4-benzyloxy-3-pyrrolin-2-one, 5-benzyl-1H-pyrrolo[2,3-c]pyridine-3-carboxyaldehyde, N-benzylphthalimide, 3,4-bis(acetoxymethyl)furan, bis[(benzo-15-crown-5)-15-ylmethyl] pimelate, 1,4-bis(5-phenyloxazol-2-yl)benzene, 1,2-bis(4-pyridyl)ethane, 1,2-bis(2-pyridyl)ethylene, 1,3-bis(3-pyridylmethyl)-2-thiourea, 2,3-bis(2-pyridyl)pyrazine, N-(2-bromobenzyloxycarbonyloxy)succinimide, 3-carboxy-1,4-dimethyl-2-pyrroleacetic acid, 2-coumaranone, coumarin, coumarin-3-carboxylic acid, 18-crown-6, dihydroascorbic acid, 3,4-dihydro-DL-proline, 3,5-diacetyl-1,4-dihydro-2,6-dimethylpyridine, 3,5-diacetyl-2,6-dimethylpyridine, 1,3-diacetyl-2-imidazolidinone, 2,6-diacetylpyridine, (+)-diacetyl-L-tartaric anhydride, 3,5-diacetyltetrahydropyran-2,4,6-trione, dibenzo-18-crown-6, dibenzo-24-crown-8, dibenzo-30-crown-10, dibenzofuran, dibenzothiophene, dibenzothiophene sulfone, 5,8-difluoro-1,4-benzodioxane, diglycolic anhydride, dihydro-4,4-dimethyl-2,3-furandione, 5,6-dihydro-5-methyl-4H-1,3,5-dithiazine, 2,5-dimercapto-1,3,4-thiadiazole, 4,4′-dimethyl-2,2′-dipyridyl, dimethyl-3,4-furandicarboxylate, 2,3-dimethylmaleic anhydride, ethylenediaminetetraacetic dianhydride, furfuryl sulfide, furil, homophthalic anhydride, 4-hydroxy-1,3-benzodioxol-2-one, 2-hydroxybenzothiazole, 6-hydroxy-1,3-benzoxathiol-2-one, N-(2-hydroxyethyl)phthalimide, N-hydroxysuccinimidyl acetoacetate, N-methylsuccinimide, N-phenylmaleimide, phthalazine, 1(2H)-phthalazione, phthalide, piperonal, piperonyl alcohol, piperonylic acid, 1-piperonylpiperazine, sesamol, 2-thiophenacetic acid, 3-thiophenemaleic acid, and the like. Among them, preferred are compounds having a functional group and an aromatic ring in the molecule, such as 2-mercaptobenzoxazole, benzotriazole, 2-benzooxazolinone, and phthalimide. Oxazole and triazole compounds are particularly preferred.

The melting point of the quick-drying property imparting agent used in the aqueous ink composition of the present invention is preferably in the range of 20-250° C. If the melting point of the quick-drying property imparting agent is lower than 20° C., the dye is sometimes not instantaneously precipitated and fixed at the time of drying, and this is not preferred. On the other hand, if the melting point of the quick-drying property imparting agent is higher than 250C, the effect is saturated and this is not preferred. The melting point of the quick-drying property imparting agent is more preferably in the range of 20-150° C.

Amount of the quick-drying property imparting agent in the aqueous ink composition of the present invention is preferably in the range of 0.5-10 wt %, more preferably in the range of 1-5 wt %. If the amount of the quick-drying property imparting agent is less than 0.5 wt %, the effect cannot sometimes be sufficiently exhibited. On the other hand, if the amount of the quick-drying property imparting agent is more than 10 wt %, the effect is saturated and the addition is not much effective, and, besides, ink characteristics such as viscosity is greatly changed. Furthermore, when the ink composition is used as an ink for ink jet printers, sometimes this causes clogging of head, and this is not preferred.

Solubility of the quick-drying property imparting agent in water is preferably in the range of 0.1-60 wt %, and solubility in the water-soluble solvent other than water is preferably in the range of 0.5-80 wt %. If the solubility is outside the above ranges, the quick-drying property imparting agent is sometimes not precipitated at the time of drying, and this is not preferred.

It is preferred that drying rate (A) of the ink composition containing the quick-drying property imparting agent of the present invention and drying rate (B) of the ink composition containing no quick-drying property imparting agent have the relation satisfying the following formula (1), and more preferably the relation satisfying the following formula (2).

A<2B/3 (1)

A<B/2 (2)

The drying rate is preferably not more than 6 seconds, more preferably not more than 4 seconds, most preferably not more than 2 seconds when printing is carried out using the ink composition of the present invention on the surface of a impermeable plastic film at a recording dot diameter of 386±116 μm, for example, by an ink jet printer having a nozzle pore diameter of 70 μm (ink particle diameter: 133±40 μm) in an environment of a temperature in the range of 20-25° C. and a relative humidity of 30-60%. In the case of carrying out the printing on the surface of a permeable paper other than plastic films, the higher drying rate can be obtained.

The total amount of the components other than water and the water-soluble solvent is preferably in the range of 5-10 wt % based on the weight of the aqueous ink composition. If the total amount is less than 5 wt %, sufficient emission intensity or fixability cannot sometimes be obtained, and this is not preferred. On the other hand, if it exceeds 10 wt %, these effects are saturated, and viscosity increases to often cause clogging of head, and this is not preferred.

Viscosity of the aqueous ink composition of the present invention is preferably in the range of 1-8 cP. If the viscosity is outside this range, printing cannot sometimes be stably performed. Flash point of the ink composition is preferably not lower than 20° C. If the flash point is lower than 20° C., flammability increases and this is not preferred.

When printing is carried out using the ink composition of the present invention on non-absorbent materials which do not absorb inks, such as polystyrene films, as printing materials, it is preferred to add at least one of silicone-based surface treating agents or fluorine-based surface treating agents to the ink composition. The aqueous ink composition is low in surface tension and is high in wettability with the non-absorbent materials, and, hence, the ink composition is apt to blot on the non-absorbent materials. However, the ink composition containing the above surface treating agent lowers in wettability and the blotting can sometimes be inhibited. As the silicone-based surface treating agents, there may be used BYK manufactured by BYK-Chemie Co., Ltd., and various silicone compounds manufactured by Shin-Etsu Chemical Co., Ltd., Toray Silicone Co., Ltd., Chisso Corporation, Toshiba Silicone Co., Ltd., and others. As the fluorine-based surface treating agents, there may be used various fluorine compounds such as SURFLON manufactured by Asahi Glass Co., Ltd., FLUORADE manufactured by 3M Co., Ltd., MEGAFAC manufactured by Dainippon Ink & Chemicals Inc., and fluorine compounds manufactured by Daikin Kogyo Co., Ltd. Particularly, the silicone-based surface treating agents are cheaper, higher in stability and solubility and less in bubbling than the fluorine-based surface treating agents, and are preferred.

Amount of these surface treating agents added to the ink composition is preferably in the range of 0.01-2 wt %. If the amount of the surface treating agents added to the ink composition is less than 0.01 wt %, the desired effects cannot be obtained. On the other hand, if the amount of the surface treating agents is more than 2 wt %, there is the possibility of giving an adverse effect on the ink characteristics such as viscosity, and this is not preferred.

The aqueous ink composition of the present invention may contain various additives which are contained in usual ink compositions, such as binders, charge donating agents, pH adjusters, fluorescent sensitizers, surface treating agents, surface active agents, leveling agents, anti-foaming agents, germicides, and antioxidants. The binders include, for example, vinyl resins such as polyvinyl alcohol, polyvinyl butyral and polyvinyl acetate, urethane resins, phenolic resins, polyester resins, acrylic resins, cellulosic resins, polyamides, maleic resins, and copolymers thereof. The charge regulators include, for example, lithium salts such as LiNO₃, potassium salts such as KCN and KSCN, and cation compounds such as tetraphenylphosphonium bromide. The pH adjusters include, for example, amine compounds such as diethanolamine, triethanolamine and triethylenetetramine, amide compounds, hydroxides such as lithium hydroxide, sodium hydroxide and potassium hydroxide, and carbonates. The fluorescent sensitizers include, for example, phosphorus compounds such as phosphine oxide compounds, phosphine sulfide compounds and phosphine compounds, and nitrogen-containing organic compounds such as benzotriazole.

The aqueous ink composition of the present invention can be prepared using medium stirring mills, for example, container driving medium mills such as ball mills, centrifugal mills and planetary ball mills, high-speed rotary mills such as sand mills, and stirring tank type mills, or simple dispersing machines such as disper.

The prints produced using the aqueous ink composition of the present invention containing a fluorescent dye are completely or substantially invisible to the naked eyes and cannot be identified. The prints produced using a fluorescent dye containing a rare earth element such as europium can be recognized only when they are irradiated with ultraviolet rays and emit red light in the visible light region. When neodymium is used as the rare earth element of the luminescence center, the prints emit light in the infrared region upon excitation with infrared rays and can be detected only by an exclusive detector. These prints of the present invention which emit visible light and infrared light are both normally invisible, and due to these features, the ink composition of the present invention can be applied to various cards such as for security, FA and others.

When bar codes are printed with the aqueous ink compositions of the present invention which contain dyes other than fluorescent dyes, black and white bar code printing can be improved. That is, the conventional black and white bar code printing has the defect that it damages the appearance of articles while according to the ink composition of the present invention this defect can be overcome. The bar code printing which uses the aqueous ink composition of the present invention can also be utilized for mailing to which a system of distributing postal matters classified by code control.

As printing methods carried out using the aqueous ink compositions of the present invention, there may be employed all of the known printing methods, such as ink jet printing, offset printing, gravure printing, heat sensitive transfer printing, and the like. The aqueous ink compositions of the present invention are especially suitable for ink jet printing. Since the ink compositions of the present invention are dissolved or stably dispersed in aqueous solvents, they do not cause clogging of nozzles of ink jet printers and can be stably discharged from the nozzles.

Furthermore, the aqueous ink compositions of the present invention may be used as inks for all systems such as ink jet printing, offset printing, gravure printing, heat sensitive transfer printing, and the like, but ink jet printing is more preferred.

### DESCRIPTION OF PREFERRED EMBODIMENTS

The aqueous ink composition of the present invention will be specifically illustrated. All parts are by weight.

### EXAMPLE 1

| | |
|---|---|
| Thenoyltrifluoroacetone | 10.6 parts |
| Ethanol | 274.0 parts |
| Europium (III) nitrate · hexahydrate | 3.0 parts |
| Deionized water | 274.0 parts |

Sodium hydroxide was added to the above components under being stirred by a magnetic stirrer to adjust the pH to 6-7. Then, thereto was added 22.3 parts of polyvinyl pyrrolidone K30 (manufactured by Wako Jun-Yaku Kogyo Co., Ltd.) as a water-soluble resin, followed by stirring at 60° C. for 3 hours and then filtration to obtain a phosphor solution A.

Furthermore, to the resulting phosphor complex solution A (phosphor dye from which the solvents are removed is referred to as “phosphor dye A”) were added 0.2 part of BYK-348 (manufactured by BYK Chemie Co., Ltd.) as a surface treating agent and 17.0 parts of 1,2,3-benzotriazole as a quick-drying property imparting agent, followed by stirring at 25° C. for 1 hour and then filtration to obtain an aqueous ink composition A.

### EXAMPLE 2

An aqueous ink composition B was obtained in the same manner as in Example 1, except that 1,2,3-benzotriazole of the quick-drying property imparting agent used in Example 1 was changed to 2-mercaptobenzoxazole.

### EXAMPLE 3

An aqueous ink composition C was obtained in the same manner as in Example 1, except that 1,2,3-benzotriazole of the quick-drying property imparting agent used in Example 1 was changed to 2-benzoxazolinone.

### EXAMPLE 4

An aqueous ink composition D was obtained in the same manner as in Example 1, except that neodymium nitrate.hexahydrate was used in place of europium nitrate.hexahydrate used in Example 1 to obtain a phosphor solution B (phosphor dye from which the solvents are removed is referred to as “phosphor dye B”).

### EXAMPLE 5

An aqueous ink composition E was obtained in the same manner as in Example 1, except that BYK-348 of the surface treating agent used in Example 1 was not used.

### COMPARATIVE EXAMPLE 1

An aqueous ink composition F was obtained in the same manner as in Example 1, except that 1,2,3-benzotriazole of the quick-drying property imparting gent used in Example 1 was not used.

### COMPARATIVE EXAMPLE 2

| | |
|---|---|
| Thenoyltrifluoroacetone | 12.6 parts |
| Ethanol | 548.0 parts |
| Europium (III) nitrate · hexahydrate | 3.0 parts |

Sodium hydroxide was added to the above components under being stirred by a magnetic stirrer to adjust the pH to 6-7. Then, thereto was added 22.3 parts of polyvinyl pyrrolidone K30 (manufactured by Wako Jun-Yaku Kogyo Co., Ltd.) as a water-soluble resin, followed by stirring at 60° C. for 3 hours and then filtration to obtain a phosphor solution G (phosphor dye from which the solvents are removed is referred to as “phosphor dye G”).

Furthermore, to the resulting phosphor solution G were added 0.2 part of BYK-348 (manufactured by BYK Chemie Co., Ltd.) as a leveling agent and 17.0 parts of 1,2,3-benzotriazole as a quick-drying property imparting agent; followed by stirring at 25° C. for 1 hour and then filtration to obtain an aqueous ink composition G.

### COMPARATIVE EXAMPLE 3

An aqueous ink composition H was obtained in the same manner as in Comparative Example 2, except that 1,2,3-benzotriazole of the quick-drying property imparting agent used in Comparative Example 2 was not used.

### COMPARATIVE EXAMPLE 4

A composition having a pH of 9.8 and comprising 4 parts of AQRYLAC #200 (trademark for acrylic acid-modified shellac resin manufactured by Shellac Industries Co., Ltd.), 2 parts of ethylene glycol monoethyl ether, 5 parts of isopropyl alcohol, 10 parts of methanol, 37 parts of ethanol, 0.5 part of Eu-TTA phosphor (phosphor dye D), 38 parts of distilled water and trimethylamine for pH adjustment was purified by a membrane filter of 1.0 μm in pore size to obtain an aqueous ink composition I (ink composition was prepared in the same manner as in Example 1 of JP-B-54-22336, except that amount of the distilled water was changed from 75 parts to 38 parts and 37 parts of ethanol was added).

### COMPARATIVE EXAMPLE 5

54.8 Parts of ethanol, 1.6 part of LUMILUX Red CD331 (Hoechlanese-Celanese, phosphor dye E), 36.6 parts of deionized water, 1.2 part of polyvinyl pyrrolidone (ISP Corp. K30), 5.5 parts of SURKOPAK 5322 (MITCHANOL) and 0.3 part of lithium nitrate were mixed and stirred to obtain an aqueous ink composition J (ink composition was prepared in the same manner as in the composition No.9 of JP-A-11-510213, except that the mount of ethanol was changed from 81.4 parts to 54.8 arts and that of distilled water was changed from 10 arts to 36.6 parts in the composition No.9 of JP-A-11-510213).

### COMPARATIVE EXAMPLE 6

274.0 parts of ethanol, 274.0 parts of ion exchanged water, 3.0 parts of rhodamine B (phosphor dye F), 22.3 parts of polyvinyl pyrrolidone (ISP Corp. K-30), 1.8 parts of lithium nitrate and 17.0 parts of 1,2,3-benzotriazole were mix and stirred to obtain an aqueous ink composition K.

### COMPARATIVE EXAMPLE 7

An aqueous ink composition L was obtained in the same manner as in Example 1, except that 1,2,3-benzotriazole of the quick-drying property imparting agent used in Example 1 was changed to sodium acetate.

Measurement of Drying Time of Print and Dot Diameter

Using the ink compositions prepared in Examples 1-5 and Comparative Examples 1-7, printing was carried out on polystyrene films by an ink jet printer 170i (pore diameter of head nozzle: 70 μm) manufactured by Marconi Data System Japan Co., Ltd. After lapse of a given time, the print was rubbed with a brush for paint and the time before the print disappeared by the rubbing was measured. Furthermore, dot diameter of the print was measured. The results of measurement are shown in the following Table 1.

Evaluation of Solubility of Phosphor Dye

Solubility in water of each phosphor dye was measured. The dye which was solved in water at 25° C. at 10 wt % or more was rated as “∘”, and one which was solved in water at 25° C. at less than 10 wt % was rated as “×”.

Evaluation of Solubility of Quick-drying Property Imparting Agent

Solubility in water of each quick-drying property imparting agent was measured. The quick-drying property imparting agent which was solved in water at 25° C. at 10 wt % or more was rated as “∘”, and one which was solved in water at 25° C. at less than 10 wt % was rated as “×”.

TABLE 1

| | | | | | | | Solubility of | Drying | Dot |
|---|---|---|---|---|---|---|---|---|---|
| | | | | Quick-drying | Surface | | quick-drying | time | diameter |
| | Ink | | | property imparting | treating | Solubility | property | of print | of print |
| Example | composition | Phosphor dye | Ink solvent | agent | agent | of dye | imparting agent | [sec] | [mm] |
| Example 1 | Aqueous ink | Phosphor dye A | Ethanol/water | 1,2,3-benzotriazole | BYK-348 | X | X | 2.0 | 0.5 |
| | composition A | | | | | | | | |
| Example 2 | Aqueous ink | Phosphor dye A | Ethanol/water | 2-mercapto- | BYK-348 | X | X | 1.8 | 0.5 |
| | composition B | | | benzoxazole | | | | | |
| Example 3 | Aqueous ink | Phosphor dye A | Ethanol/water | 2-benzoxazolinone | BYK-348 | X | X | 1.9 | 0.5 |
| | composition C | | | | | | | | |
| Example 4 | Aqueous ink | Phosphor dye B | Ethanol/water | 1,2,3-benzotriazole | BYK-348 | X | X | 1.9 | 0.5 |
| | composition D | | | | | | | | |
| Example 5 | Aqueous ink | Phosphor dye A | Ethanol/water | 1,2,3-benzotirazole | No | X | X | 1.6 | 0.9 |
| | composition E | | | | | | | | |
| Comparative | Aqueous ink | Phosphor dye A | Ethanol/water | No | BYK-348 | X | — | 6.4 | 0.5 |
| Example 1 | composition F | | | | | | | | |
| Comparative | Ink | Phosphor dye C | Ethanol | 1,2,3-benzotirazole | BYK-348 | X | X | 1.6 | 0.5 |
| Example 2 | composition G | | | | | | | | |
| Comparative | Ink | Phosphor dye C | Ethanol | No | BYK-348 | X | — | 1.6 | 0.5 |
| Example 3 | composition H | | | | | | | | |
| Comparative | Ink | Phosphor dye D | Ethanol/water | No | No | X | — | 6.2 | 0.8 |
| Example 4 | composition I | | | | | | | | |
| Comparative | Ink | Phosphor dye E | Ethanol/water | No | No | X | — | 6.1 | 0.8 |
| Example 5 | composition J | | | | | | | | |
| Comparative | Ink | Phosphor dye F | Ethanol/water | 1,2,3-benzotriazole | No | ◯ | X | 4.8 | 0.8 |
| Example 6 | composition K | | | (98° C.) | | | | | |
| Comparative | Ink | Phosphor dye A | Ethanol/water | Sodium acetate | No | X | ◯ | 5.8 | 0.8 |
| Example 7 | composition L | | | (324° C.) | | | | | |

From the results shown in Table 1, it was confirmed that the ink compositions A-E of the present invention had drying property quicker than that of the conventional ink compositions F, I, J, K and L to which the quick-drying property imparting agent was not added. Moreover, it was confirmed that the ink compositions of the present invention had drying property similar to that of the ethanol-based ink compositions G and H in which water was not used as the solvent. Furthermore, the ink compositions to which the surface treating agent was added gave smaller dot diameter and less blotting than those to which the surface treating agent was not added.

As explained above, the aqueous ink compositions of the present invention can show excellent drying property as compared with the conventional aqueous ink compositions. Furthermore, there can be obtained safe aqueous ink compositions which are mild for environment and less in problems, namely, environmental pollution such as air pollution, labor safety and hygiene such as organic solvent poisoning, and danger of ignition and explosion.

What is claimed is:

1. An aqueous ink composition which contains water, -a water-soluble solvent, a water-soluble resin and a dye, and additionally a quick-drying property imparting agent, wherein the dye has a solubility in the water lower than a solubility in the water-soluble solvent, solubility in water of the dye is 10 wt % or lower, and the quick-drying property imparting agent has a solubility in the water lower than a solubility in the water-soluble solvent.

2. An aqueous ink composition according to claim 1, wherein content of the water in the ink composition is in the range of 30-95 wt %, ratio of the contents of the water and the water-soluble solvent is in the range of 9:1-3:7, and boiling point of the water-soluble solvent is lower than that of the water or vapor pressure of the water-soluble solvent is higher than that of the water.

3. An aqueous ink composition according to claim 1, wherein solubility of the quick-drying property imparting agent in water is in the range of 0.1-60 wt %, and solubility of the quick-drying property imparting agent in the water-soluble solvent is in the range of 0.5-80 wt %.

4. An aqueous ink composition according to claim 1, wherein melting point of the quick-drying property imparting agent is in the range of 20-250° C., solubility in water of the quick-drying property imparting agent is 10 wt % or lower, and content of the quick-drying property imparting agent in the ink composition is in the range of 0.5-10 wt %.

5. An aqueous ink composition according to claim 1, wherein the quick-drying property imparting agent is at least one compound selected from the group consisting of oxazole compounds and triazole compounds.

6. An aqueous ink composition according to claim 5, wherein the quick-drying property imparting agent is at least one compound selected from the group consisting of 1,2,3-benzotriazole, benzotriazole-5-carboxylic acid, 1H-benzotriazole-1-methanol, N-(1H-benzotriazol-1-ylmethyl)formamide, benzoxazole, 2-mercaptobenzoxazole, 4-benzylamino-7-nitro-2,1,3-benzoxadiazole, and 2-benzoxazolinone.

7. An aqueous ink composition according to claim 1 or 2, wherein the water-soluble solvent is at least one solvent selected from the group consisting of alcohol, ketone and ether solvents.

8. An aqueous ink composition according to claim 7, wherein the water-soluble solvent is at least one solvent selected from the group consisting of alcohols of not more than 3 carbon atoms.

9. An aqueous ink composition according to claim 8, wherein the water-soluble solvent is ethanol or propanol.

10. An aqueous ink composition according to claim 1, wherein the water-soluble resin is at least one resin selected from the group consisting of polyvinylpyrrolidone, polyvinyl alcohol, polyurethane, polyacrylic acid, polyether and copolymers thereof.

11. An aqueous ink composition according to claim 1, wherein content of the water-soluble resin in the ink composition is in the range of 0.1-8 wt %.

12. An aqueous ink composition according to claim 1, wherein the dye is at least one dye selected from the group consisting of fluorescent dyes, inorganic dyes, organic dyes and solvent-insoluble dyes, and solubility of the dye in water at 25° C. is not higher than 10 wt %.

13. An aqueous ink composition according to claim 12, wherein the dye is a fluorescent dye containing a rare earth element and a ligand.

14. An aqueous ink composition according to claim 13, wherein the rare earth element in the fluorescent dye is europium and the ligand is thenoyltrifluoroacetone or naphthoyltrifluoroacetone.

15. An aqueous ink composition according to claim 1, wherein content of the fluorescent dye in the ink composition is in the range of 0.1-5 wt %.

16. An aqueous ink composition according to claim 1, wherein the total content of the components of the ink composition other than the water and the water-soluble solvent is in the range of 5-10 wt %.

17. An aqueous ink composition according to claim 1 which additionally contains at least one surface treating agent selected from the group consisting of silicone-based surface treating agents and fluorine-based surface treating agents.

18. An aqueous ink composition according to claim 17, wherein content of the surface treating agent in the ink composition is in the range of 0.01-2 wt %.

19. An aqueous ink composition according to claim 1 which additionally contains at least one additive selected from the group consisting of binders, charge donating agents, pH adjusters, fluorescent sensitizers, surface treating agents, surface active agents, leveling agents, anti-foaming agents, germicides, and antioxidants.

20. An aqueous ink composition according to claim 1 which has a viscosity in the range of 1-8 cP and a flash point of not lower than 20° C.
